(19) United States
(12) Patent Application Publication
(10) Pub. No.: US 2002/0154977 A1
(43) Pub. Date: Oct. 24, 2002

(54) Wafer transport system and method

(76) Inventor: Woo Sik Yoo, Palo Alto, CA (US)

Correspondence Address: SKJERVEN MORRILL LLP, 25 METRO DRIVE, SUITE 700, SAN JOSE, CA, 95110, US

(21) Appl. No.: 09/838,083

(22) Filed: Apr. 19, 2001

(51) Int. Cl. B65G 65/04

(52) U.S. Cl. 414/416.06; 414/811

(57) ABSTRACT

A system and method for transporting semiconductor wafers in a semiconductor processing system, which may include a transport module and a process chamber. The system includes a container configured to house a plurality of semiconductor wafers, where the container is a separate component from the semiconductor processing system. A semiconductor wafer transport device is disposed in the transport module, which is configured to extend into the container from the transport module and deliver the semiconductor wafers to the process chamber.

### BACKGROUND

1. Field of the Invention

This invention relates to semiconductor wafer processing systems, and more particularly to a system and method for the transfer of semiconductor wafers to a processing chamber.

2. Related Art

Semiconductor wafer processing systems, for example, those designed for use with 300 mm diameter semiconductor wafers, typically require an interface with a separate container. In industry, the separate container is referred to as a Front Opening Unified Pod (FOUP). Semiconductor wafer transfer systems including FOUPs are substantially retrofit systems, where the FOUP is made to interface with an existing wafer transfer system, and can require additional hardware be added to move semiconductor wafers from the FOUP to the process chamber of the processing system.

In addition to the additional hardware requirements, retrofit wafer transport systems can require transport mechanisms that must translate along multiple axes for transporting the wafers through the processing system. For example, in the simplified illustration of a transport system shown in FIG. 1A, a single FOUP 2 can be accessed by a first transport mechanism 3, which moves wafers from FOUP 2 to a loadlock or other storage location 4. Storage location 4 must then be accessed by a second transport mechanism 5 to move the wafers to process chamber 8. Alternatively, as shown in FIGS. 1B and 1C, the automated transport system may include multiple FOUPs 2. In this example, transport device 3 must translate laterally along a y-axis direction in front of each FOUP 2, to access the wafers contained in each FOUP 2. First transport mechanism 3 moves back to a position in front of storage location 4 to continue transporting the wafers to process chamber(s) 8. Unfortunately, the need for multiple transport mechanisms and the ability for transport mechanisms to translate laterally require considerable floor space, which is typically available at a premium in wafer processing facilities.

### SUMMARY

The present invention provides a wafer transport system and method, which eliminates the need for using multiple transport devices and the need for lateral translation of transport devices when transporting semiconductor wafers.

In one aspect of the invention a method is provided for transporting semiconductor wafers. The method includes providing a semiconductor processing system including a transport module and a process chamber, and extending a semiconductor wafer transport device from the transport module into an adjacently positioned container. The container is a separate component from the thermal processing system. The method also includes removing at least one semiconductor wafer from the container using the wafer transport device.

In another aspect of the present invention, a system is provided for transporting semiconductor wafers. The system includes a processing system, which includes a transport module and a process chamber. The system also includes a container configured to house a plurality of semiconductor wafers, where the container is a separate component from the processing system. A semiconductor wafer transport device is disposed in the transport module, which is configured to extend into the container from the transport module and deliver the semiconductor wafers to the process chamber.

These and other features and advantages of the present invention will be more readily apparent from the detailed description of the preferred embodiments set forth below taken in conjunction with the accompanying drawings.

### BRIEF DESCRIPTION OF THE FIGURES

FIGS. 1A-1C are simplified illustrations of typical transport systems, which require multiple transport devices and/or the need for lateral translation of transport devices for moving semiconductor wafers;

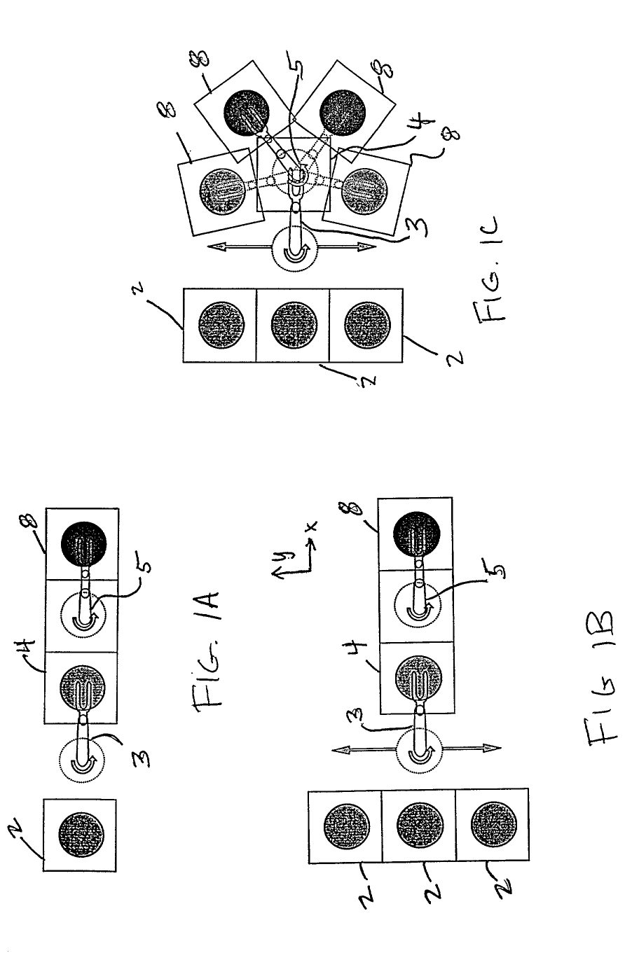

FIGS. 2A and 2B are simplified side and top views, respectively, of a wafer processing system and a FOUP or similar container in accordance with an embodiment of the present invention;

FIG. 3 is a simplified perspective view of the wafer processing system including the gate valve assembly of FIG. 2A;

FIGS. 4 is a flow diagram of an embodiment of a process in accordance with the present invention; and

FIGS. 5A and 5B are simplified illustrations of another embodiment in accordance with the present invention.

### DETAILED DESCRIPTION

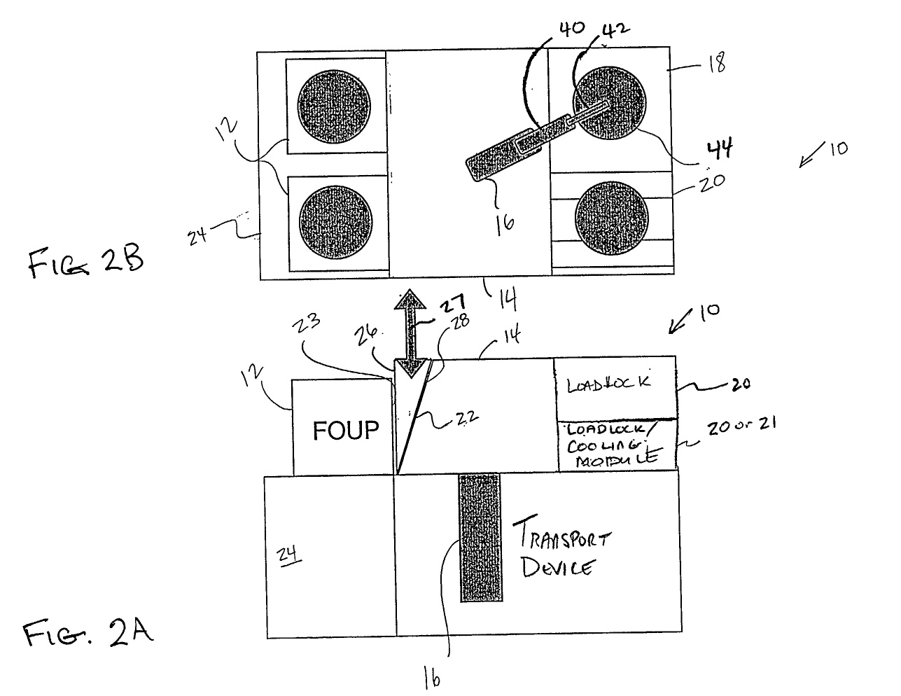

FIGS. 2A and 2B are simplified side and top views, respectively, of a semiconductor wafer processing system 10 and a wafer container 12. Wafer processing system 10 can include a transport module 14, a transport device 16, a process chamber 18, a loadlock or storage module 20 and a cooling module 21.

Wafer container 12 can be any suitable container for housing semiconductor wafers of various diameters. For example, container 12 can include a wafer cassette capable of housing wafers with diameters ranging from about 100 mm to about 300 mm or more. In one embodiment, with no intent to limit the invention, wafer container 12 may be a FOUP 12 or alternatively, a plurality of FOUPs 12 (FIG. 2B). FOUP 12 may include a front opening 23 that faces a wafer transport module 14 including a transport device 16 for exchanging wafers between FOUP 12, process chamber 18, loadlock 20 and/or cooling module 21. The operation and functions performed by transport device 16, process chamber 18, loadlock 20 and cooling module 21 are generally well known and understood by those of ordinary skill in the art.

FOUP 12 may generally include a container portion and a cooperating front door. The container portion has a plurality of wafer slots for holding semiconductor wafers in substantially a horizontal orientation. Typically, FOUP 12 can have a capacity of up to twenty-five wafers. In one embodiment, FOUP 12 includes a mechanism (not shown) for removing the front door of FOUP 12 and lowering the front door into a base unit 24. In this embodiment, the door is automatically unlocked, moved vertically into base unit 24, and then pivoted to a position below FOUP 12.

As shown n FIG. 2A, transport module 14 includes an upper opening 22, aligned with front opening 23 of FOUP 12, and a gate valve assembly 26, provided for closure to upper opening 22. Upper opening 22 and front opening 23 provide access for the loading and unloading of wafers 44 before and after processing. Openings 22 and 23 may be relatively small openings, but with a height and width large enough to accommodate a wafer 44 of between about 0.5 mm to about 2 mm thick and up to about 300 mm (˜12 in.) in diameter, and a robot arm passing therethrough. In one embodiment, the height of the aperture is no greater than between about 18 mm and 50 mm, and preferably, no greater than 20 mm. The relatively small opening size helps to reduce radiation heat loss from processing system 10. Also, the small opening size keeps down the number of particles entering processing system 10 and allows for easier maintenance.

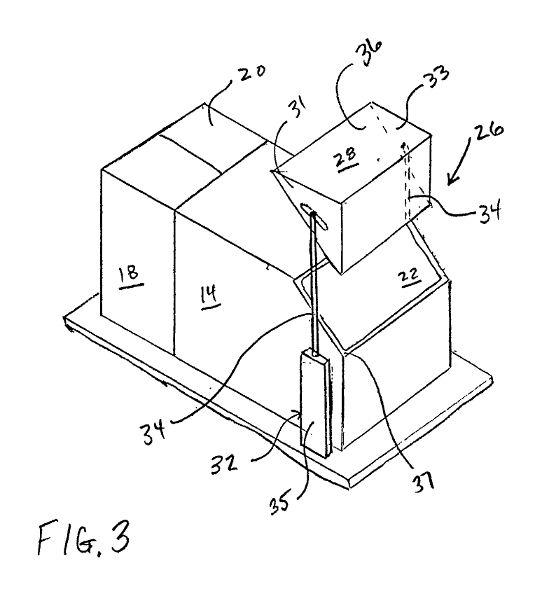

In one embodiment, a gate valve assembly 26 can be formed with, or mounted on, transport module 14 to provide a closeable/sealable access through upper opening 22. FIG. 3 is a simplified illustration of an embodiment of gate valve assembly 26. In this embodiment, gate valve assembly 26 includes a gate 28 coupled to a pair of actuators 32. The geometry and dimensions of gate 28 generally correspond to those of opening 22 of transport module 14, so that gate 28 can be used to provide a closure to isolate transport module 14. Optionally, gate 28 can provide a sealed closure to maintain a selected vacuum or pressurized environment within processing system 10 during wafer processing operations.

As shown in the embodiment of FIG. 3, gate 28 is an elongated plate coupled at each end 31 and 33 to a pair of linear drive shafts 34 each stemming from a main body 35 of actuators 32. The elongated plate is well suited for sealing slot-type openings, such as upper opening 22. It should be understood that the geometry of gate 28 may be changed to accommodate differently shaped or sized openings.

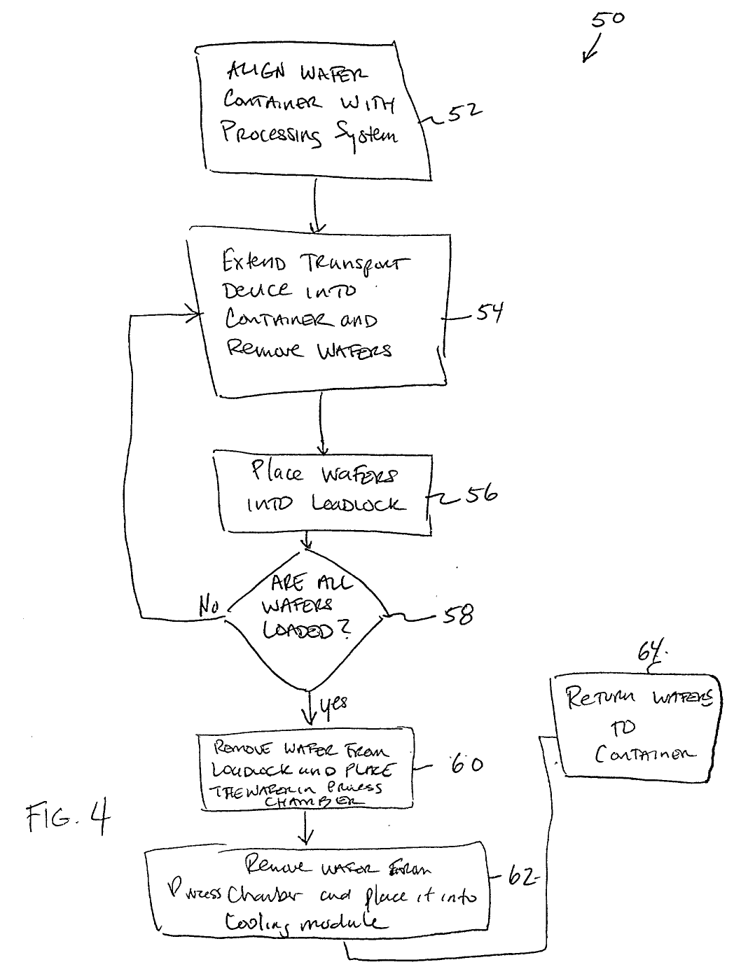

As shown in FIG. 4, gate 28 may be sloped relative to the direction of actuation (arrow 27, FIG. 2A) to form an inclined surface 36. The sloped surface provides gate valve assembly 26 a narrower profile, which allows process system 10 to maintain a small footprint. For example, inclined surface 36 may be sloped at any angle, such as between about 5° and about 85°, which is adequately suited to allow for the proper performance of the present invention. In one embodiment, inclined surface 36 is angled at between about 30° and about 60°, more preferably about 45° to the direction of actuation.

Optionally, on a top and bottom portion of inclined surface 28 are contact portions, which extend along the elongated length of gate 28. An O-ring (not shown) may be provided on the contact portions to provide a seal, if desired. The contact portions of inclined surface 36, which may contact portions of transport module 14 at opening 22, may be coated with a soft buffer material to avoid metal-to-metal sliding contact, which helps to avoid the creation of contaminating particles.

By way of example, with no intent to limit the invention thereby, when drive shafts 34 are moved out of main bodies 35, gate 28 is moved upward, away from opening 22 to provide a throughway. Drive shafts 34 are moved up and/or down by a linear action created using actuators 32. For example, in one embodiment, to move drive shafts 34, actuators 32 are supplied at a plumbing interface with a conventional fluid, such as compressed gas, water or alcohol. The supply of fluid causes drive shafts 34 to move linearly through main bodies 35. The function and operation of actuators 32 are generally well known by those of ordinary skill in the art and are generally commercially available.

To close gate valve assembly 26, drive shafts 34 are moved down into main bodies 35 of actuator 32, thus providing isolation of transport module 14 and/or optionally creating a seal.

A type of gate valve assembly is disclosed in co-pending U.S. patent application Ser. No. 09/451,664, filed Nov. 30, 1999, which is herein incorporated by reference for all purposes.

Transport module 14 also includes a transport device 16 operatively within transport module 14. In accordance with the invention, transport device 16 may be a robot 16 provided for transporting wafers 44 to and from the modules of processing system 10, such as between transport module 14, process chamber 18, loadlock 20 and cooling module 21. In one embodiment, robot 16 includes a robot arm 40 and an end-effector 42, each of which may be made of a heat resistant material such as quartz, for picking-up and placing wafers 44. End-effector 42 can be fixedly attached to an attachment block on the end of robot arm 40, which accepts a variety of end-effectors 42.

In one embodiment, robot 16 includes robot arm 40 made of multi-linkages capable of performing an S-motion or snake motion. The S-motion allows robot 16 to be positioned in a fixed location of processing system 10, while robot arm 40 is capable of accessing each module of processing system 10. A robot of this type, for example, model number AR-K150CL-3-S-325 is available from Hirata Corporation, Kumamoto City, Japan. Another type of robot suitable for use with the present invention is disclosed in co-pending U.S. patent application Ser. No. 09/451,677, filed Nov. 30, 1999, which is herein incorporated by reference for all purposes.

In one embodiment, processing system includes a process chamber 18, such as a single wafer rapid thermal processing (“RTP”) reactor, a mini batch furnace, annealing chamber, a chemical vapor deposition (CVD) chamber and the like. Alternatively, process chamber 18 may be a plurality of each of these examples, which are generally horizontally displaced. However, in one embodiment, the plurality of process chambers 18 are vertically displaced (i.e., stacked one over another) to minimize floor space occupied by processing system 10 and to allow for the simultaneous processing of wafers. It should be understood that the invention is not limited to a specific number or type of process chamber and may use any semiconductor processing chamber, such as those used in physical vapor deposition, etching, impurity doping and ashing.

Process chamber 18 generally defines an interior cavity. For example, the interior cavity may be constructed with a substantially rectangular cross-section, having a minimal internal volume, usually no greater than 1.0 m³, preferably less than about 0.3 m³. One result of the small volume is that uniformity in temperature is more easily maintained. Additionally, the small volume allows process chamber 18 to be made smaller, and as a result, processing system 10 may be made smaller, requiring less clean room floor space. To conduct a process, process chamber can be pressurized, typically, process chamber 18 can have an internal pressure of between about 0.001 Torr to 1000 Torr, preferably between about 0.1 Torr and about 760 Torr. One type of suitable process chamber 18 is disclosed in co-pending, commonly assigned U.S. patent application Ser. No. 09/451,494, filed Nov. 30, 1999, herein incorporated by reference.

The flow diagram of FIG. 4, in conjunction with FIGS. 2A, 2B and 3, disclose a method 50 for the movement of wafers 44 from FOUP 12, to loadlock 20, and ultimately to process chamber 18. In operation, transport device 16 is capable of reaching into FOUP 12 to lift wafers 44 and move them to a location within wafer processing system 10. FOUP 12 is placed in position adjacent to transport module 14 and gate valve assembly 26 (action 52). The door of FOUP 12 is lowered providing access through opening 23 to wafers 44 contained therein. Gate valve assembly 26 is also opened allowing robot arm 40 of robot 16 to be extended through opening 22. Wafer transport device 16 being disposed in a fixed position in transport module 14, rotates and lowers towards opening 22 and extends robot arm 40 in to opening 23 of FOUP 12 (action 54). Robot arm 40 extends end-effector 42 into opening 23 to pick-up a wafer 44 and remove it from FOUP 12. Robot arm 40 then retracts and rotates towards loadlock 20 where the wafer is placed to await processing (action 56). This process is repeated until all of wafers 44 have been off-loaded from FOUP 12 into loadlock 20 (action 58). After all wafers 44 have been loaded into loadlock 20, gate valve assembly 26 can be closed to isolate transport module 14.

Robot 16 removes each wafer 44 from loadlock 20 and positions each wafer 44 within chamber 18 for processing (action 60). Robot arm 40 then retracts and, subsequently, the processing of wafer 44 begins in a well known manner.

After wafer 44 is processed, robot 16 returns to pick-up and place wafer 44 into a cooling module 21 (action 62). Cooling module 21 allows the newly processed wafers, which may have temperatures upwards of 100° C., to cool before they are placed back into loadlock 20. Once cooled, each wafer 44 can be returned to loadlock 20. Once each wafer has been processed, wafers 44 are returned to FOUP 12 (action 64). In some embodiments where the processing temperature does not exceed about 600° C., cooling module 21 provides only a temporary storage function similar to that of loadlock 20.

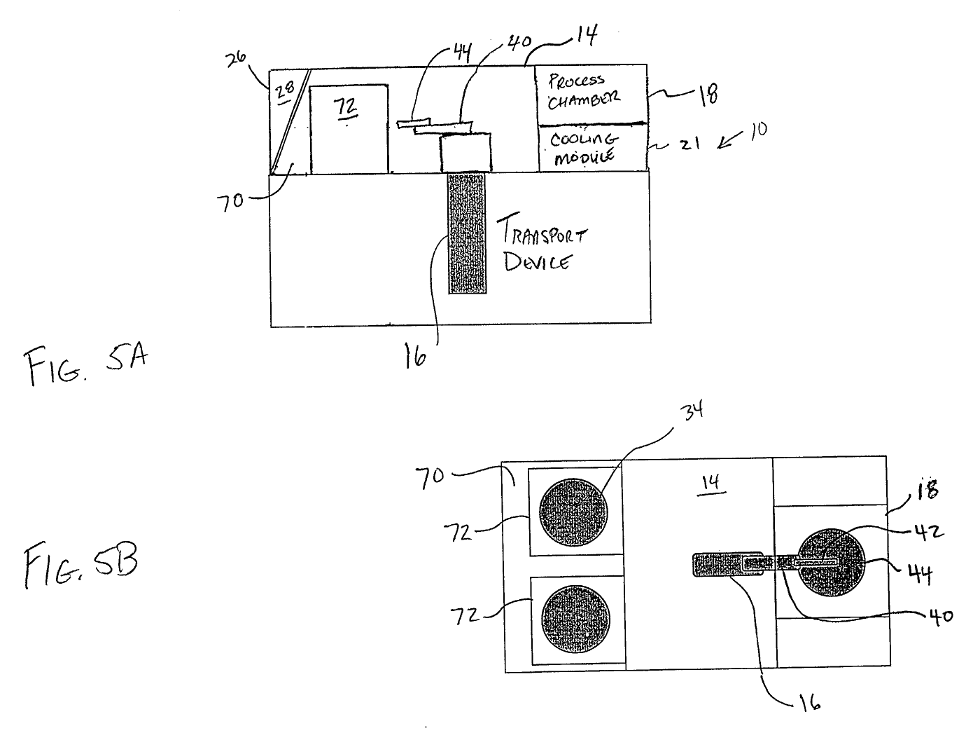

FIGS. 5A and 5B are simplified illustrations of another embodiment in accordance with the present invention. In this embodiment, transport module 14 of processing system 10 includes a loading section 70 for receiving a wafer cassette 72, or alternatively a plurality of wafer cassettes 72 (FIG. 5B). Wafer cassette 72 may be a removable cassette capable of supporting wafers of a diameter of between 100 mm and about 300 mm. Wafer cassette 72 can be loaded onto loading section 70 of transport module 14 through an open gate 28 of gate valve assembly 26, either manually or with automated guided vehicles (AGV). Once wafer cassette 72 is positioned on loading section 70 of transport module 14, gate valve assembly 26 closes to isolate processing system 10. Optionally, processing system 10 can be maintained at atmospheric pressure or else are pumped down to a vacuum pressure using a pump (not shown). Transport device 16, such as a robot, housed at a fixed position within transport module 14, rotates toward cassette 72 and picks up a wafer 34 from cassette 72.

As illustrated in FIG. 5B, process chamber 18, which may also be at atmospheric pressure or under vacuum pressure, accepts wafer 34 from robot 16. Robot 16 then retracts and, subsequently, the processing of wafer 34 is allowed to begin. After wafer 34 is processed, robot 16 returns to pick-up and place wafer 34 into cooling module 21. In this embodiment, cooling module 21 is positioned directly below process chamber 18 to conserve space. Cooling module 21 cools the newly processed wafers before they are placed back into wafer cassette 72.

Having thus described embodiments of the present invention, persons of ordinary skill in the art will recognize that changes may be made in form and detail without departing from the scope of the invention. Thus the invention is limited only by the following claims.

What is claimed is:

1. A method for transporting semiconductor wafers comprising:
providing a processing system including a transport module and a process chamber;
extending a semiconductor wafer transport device from said transport module into an adjacently positioned container, said container being a separate component from said processing system; and
removing at least one semiconductor wafer from said container using said wafer transport device.

2. The method of claim 1, wherein said wafer transport device comprises a robot including an extendible robot arm and an end-effector.

3. The method of claim 1, wherein said wafer transport device is in a fixed position.

4. The method of claim 1, wherein said container comprises a Front Opening Unified Pod (FOUP).

5. The method of claim 1, wherein said removing further comprising placing said wafers into a storage location.

6. The method of claim 1, wherein said process chamber comprises a chamber taken from the group consisting a mini batch furnace, annealing chamber, a chemical vapor deposition (CVD) chamber, and chambers used for physical vapor deposition, etching, impurity doping and ashing.

7. The method of claim 1, further comprising transporting said wafers between a cooling module and said process chamber.

8. The method of claim 1, wherein said process chamber comprises a single wafer rapid thermal processor.

9. The method of claim 1, further comprising opening a gate valve to allow said wafer transport device to extend out from said transport module and into said container.

10. A method for transporting a semiconductor wafer comprising:
providing a processing system including a transport module and a semiconductor wafer process chamber;
extending a robot including an extendible robotic arm from said transport module into an adjacently positioned Front Opening Unified Pod (FOUP), said FOUP being a separate component from said processing system, said robot being at a fixed location;
removing at least one semiconductor wafer from said FOUP and placing said at least one semiconductor wafer in said semiconductor wafer process chamber using said extendible robotic arm.

11. A system for transporting semiconductor wafers comprising:
a processing system including a transport module and a process chamber;
a semiconductor wafer transport device disposed in said transport module; and
a container configured to house a plurality of semiconductor wafers, said container being a separate component from said processing system, said semiconductor wafer transport device being configured to extend into said container from said transport module and said semiconductor wafer transport device being configured to deliver said semiconductor wafer to said process chamber.

12. The system of claim 11, wherein said wafer transport device comprises a robot including an extendible robot arm and an end-effector.

13. The system of claim 11, wherein said wafer transport device is in a fixed position within said transport module.

14. The system of claim 11, wherein said container comprises a Front Opening Unified Pod (FOUP).

15. The system of claim 11, further comprising a storage location disposed within said processing system, wherein said wafer transport device is configured to deliver said wafers into said storage location.

16. The system of claim 11, further comprising a cooling module disposed within said processing system, wherein said wafer transport device is configured to deliver said wafers into said cooling module.

17. The system of claim 11, wherein said process chamber comprises a single wafer rapid thermal processor.

18. The system of claim 11, a gate valve assembly disposed on said transport module to isolate said wafer processing system.

19. The system of claim 11, wherein said container comprises a wafer cassette.

20. A system for transporting a semiconductor wafer comprising:
a processing system including a transport module and a single wafer process chamber; and
means for accessing an adjacently positioned Front Opening Unified Pod (FOUP), said FOUP being a separate component from said processing system, said means for accessing being at a fixed position within said transport module to remove at least one semiconductor wafer from said FOUP and to place said at least one semiconductor wafer in said single wafer process chamber.
